(19) United States
(12) Patent Application Publication
(10) Pub. No.: US 2022/0275287 A1
(43) Pub. Date: Sep. 1, 2022

(54) LOOP SEAL ON REACTOR FIRST STAGE DIPLEG TO REDUCE HYDROCARBON CARRYOVER TO STRIPPER FOR NAPHTHA CATALYTIC CRACKING

(71) Applicant: SABIC Global Technologies B.V., Bergen op Zoom (NL)

(72) Inventor: Mayank KASHYAP, Sugar Land, TX (US)

(21) Appl. No.: 17/632,034

(22) PCT Filed: Jul. 21, 2020
(86) PCT No.: PCT/IB2020/056835

§ 371 Date: Feb. 1, 2022

Related U.S. Application Data
(60) Provisional application No. 62/883,065, filed on Aug. 5, 2019.

(51) Int. Cl. C10G 11/18

(52) U.S. Cl. CPC C10G 11/187; C10G 11/182; C10G 2300/1044; C10G 2300/4093; C10G 2400/20; C10G 2400/30

(57) ABSTRACT

Disclosed is a method of catalytically cracking naphtha in a fluidized bed. Effluent from the fluidized bed is separated into catalyst particles and gas product by a cyclone having a loop seal connected to the cyclone's dipleg.

### CROSS REFERENCE TO RELATED APPLICATIONS

This application claims the benefit of priority of U.S. Provisional Patent Application No. 62/883,065, filed Aug. 5, 2019, which is hereby incorporated by reference in its entirety.

### FIELD OF INVENTION

The present invention generally relates to the catalytic cracking of naphtha to produce olefins. More specifically, the present invention relates to contacting catalyst particles with naphtha under conditions to crack the naphtha and form a mixture of gas and catalyst particles and separating the gas from the catalyst particles by a cyclone that has a loop seal connected to it.

### BACKGROUND OF THE INVENTION

The catalytic cracking of naphtha is a process that converts hydrocarbon mixtures with final boiling point of under 350° C., such as naphtha, to light olefins (i.e., ethylene, propylene, and butylene) and aromatics (i.e., benzene, toluene, and xylene, or simply BTX). Reactor hydrodynamics and reaction kinetics in the catalytic cracking process can be varied to obtain a wide range of product distribution. Reactor designs can include circulating fluidized bed (CFB) reactors with various configurations, such as turbulent fluidized bed reactor (TFBR) or fast-fluidized bed reactor (FFBR). In a CFB, the product gas and spent catalyst enter the reactor and the mixture is separated in single or multiple two-three stage cyclone(s).

In theory, over 95 wt. % product gas typically leaves the CFB reactor through the effluent line at the top of the CFB reactor, while the spent catalyst goes to the bottom of the CFB reactor through the diplegs. The spent catalyst then enters the stripper along with hydrocarbon vapors adsorbed on the surface of the catalyst. These vapors are carried in two ways, first by filling the catalyst pores, and second by getting entrained with the catalyst. In a typical fluid catalytic cracking (FCC) unit, steam is used as a stripping gas to remove the entrained hydrocarbons between individual catalyst particles and a small portion of adsorbed hydrocarbons. The steam requirements are of the order of 2-5 kg steam per 1,000 kg circulated catalyst. Steam, however, deactivates the catalyst via dealumination.

### BRIEF SUMMARY OF THE INVENTION

A method has been discovered for producing olefins and/or aromatics, in which naphtha is catalytically cracked in a reactor to produce a mixture of product gas and spent catalyst and the amount of entrained hydrocarbons flowing from the reactor into a stripper is reduced, as compared to conventional methods. The method is premised on minimizing hydrocarbon carryover from cyclones in the reactor to the stripper by installing a loop-seal to restrict the flow of gas product to an extent greater than the restriction of flow of the spent catalyst such that there is separation of at least some of the gas product from the spent catalyst. In this way, the need for stripping hydrocarbons from the spent catalyst, and thereby stripping gas requirements, can be minimized and the activity of the catalyst can be more easily maintained, as compared with conventional methods, because of a lower amount of entrained hydrocarbon entering the stripper.

Embodiments of the invention include a method of producing olefins and/or aromatics. The method includes cracking naphtha, in a catalyst fluidized bed, to form a gas product comprising one or more olefins and/or one or more aromatics. The method also includes flowing a mixture comprising catalyst particles and the gas product, from the catalyst fluidized bed, to a cyclone, wherein a loop seal is in fluid communication with a first outlet (dipleg) of the cyclone. The method further includes restricting flow of the gas product through the loop seal to an extent greater than any restriction of flow of the catalyst particles through the loop seal.

Embodiments of the invention include a method of producing olefins and/or aromatics, where the method includes cracking naphtha in a catalyst fluidized bed to form a gas product comprising one or more of ethylene, propylene, butylene, benzene, toluene, and xylene. The method also includes flowing a mixture comprising catalyst particles and the gas product, from the catalyst fluidized bed, to a cyclone, wherein a loop seal is connected to and in fluid communication with a first outlet (dipleg) of the cyclone. The method further includes restricting flow of the gas product through the loop seal to an extent greater than any restriction of flow of the catalyst particles through the loop seal such that gas product to catalyst particles ratio upstream the loop seal is higher by at least 50% than gas product to catalyst particles ratio downstream the loop seal. Further yet, the method includes flowing effluent from the loop seal to a gas stripper.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a system for separating gas product from spent catalyst in the catalytic cracking of naphtha to produce olefins and/or aromatics, according to embodiments of the invention; and

FIG. 2 shows a method of producing olefins and/or aromatics, according to embodiments of the invention.

### DETAILED DESCRIPTION OF THE INVENTION

A method has been discovered for producing olefins and/or aromatics, in which naphtha is catalytically cracked in a reactor to produce a mixture of product gas and spent catalyst and a cyclone for separating product gas from spent catalyst is equipped with a loop seal that reduces the amount of entrained hydrocarbons flowing from the reactor into the stripper, as compared to conventional methods. The method is premised on minimizing hydrocarbon carryover from the first stage cyclones in the reactor to the stripper by installing a loop-seal at the bottom of the first stage dipleg. The loop-seal creates a pressure drop across the first vertical section, allowing primarily solids to flow through the first horizontal section, while forcing the downward flowing gas dragged by the catalyst to move back to the top of the dipleg. This potentially reduces gas recirculation down the dipleg by up to 90% (from as high as 33% to as low as 2%). This subsequently reduces the amount of gas required for stripping. The loop-seal concept, according to embodiments of the invention, comprises a gas distributor (e.g., sparger type) for fluidizing gas (e.g., nitrogen or methane), and multiple aeration nozzles on the vertical sections and the second horizontal section of the system to inject small quantities of aeration gas (e.g., nitrogen or methane). This concept minimizes the requirements for stripping gas to strip off the remaining entrained hydrocarbons. However, some stripping gas (e.g., nitrogen, methane, or flue gas) is still needed to strip off the remaining entrained hydrocarbons and a small amount of adsorbed hydrocarbons.

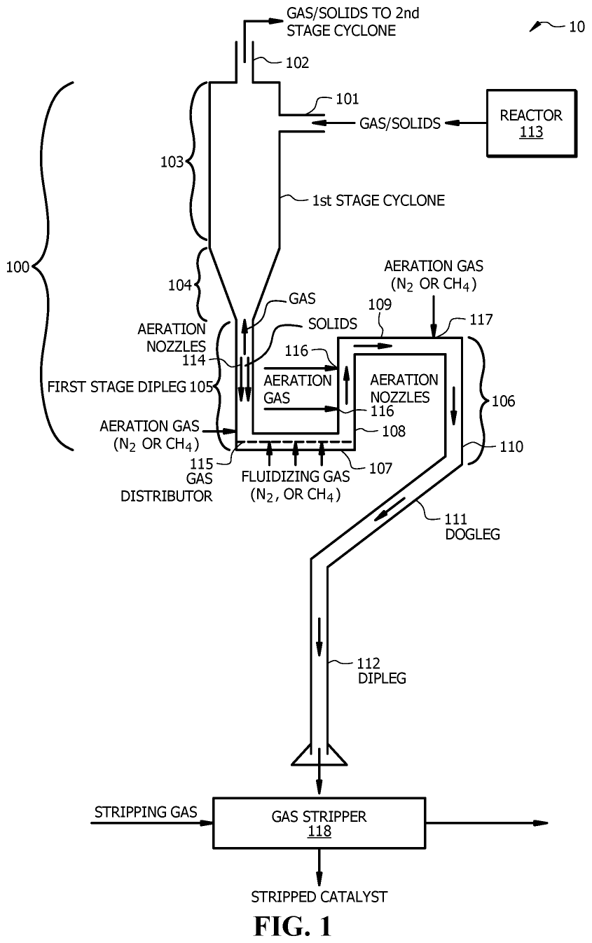

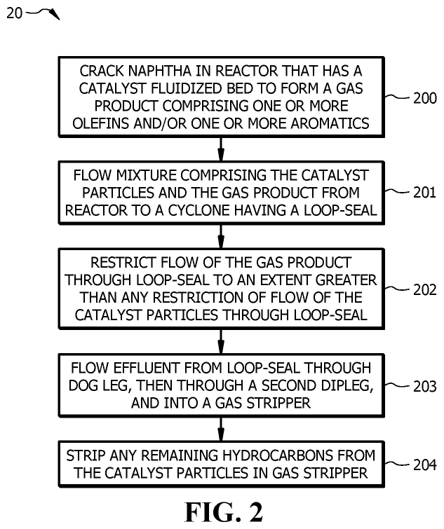

FIG. 1 shows system 10 for separating gas product from spent catalyst in the catalytic cracking of naphtha to produce olefins and/or aromatics, according to embodiments of the invention. FIG. 2 shows method 20 for separating gas product from spent catalyst in the catalytic cracking of naphtha to produce olefins and/or aromatics, according to embodiments of the invention. System 10 can be used to implement method 20.

As shown in FIG. 1, in embodiments of the invention, system 10 includes cyclone 100 having inlet 101 and top outlet 102. Cylindrical body 103 of cyclone 100 is connected to narrowing section 104, which in turn is connected to first stage dipleg 105, such that inlet 101, top outlet 102, cylindrical body 103, narrowing section 104, and first stage dipleg 105 are all adapted to be in fluid communication. According to embodiments of the invention, and as shown in FIG. 1, cyclone 100 is in fluid communication with loop-seal 106. More specifically, first stage dipleg 105 of cyclone 100 is connected to and in fluid communication to loop 106 such that material flowing downwards through cyclone 100, exits cyclone 100 through first stage dipleg 105 and flows into loop-seal 106. First stage dipleg 105 can be adapted to receive aeration gas.

In embodiments of the invention, as shown in FIG. 1, loop-seal 106 comprises first horizontal section 107, which may have a gas distributor such that fluidizing gas can be flowed into first horizontal section 107 to contact and fluidize material (such as catalyst particles) in first horizontal section 107. First horizontal section 107, according to embodiments of the invention, is connected to and in fluid communication with first vertical section 108, which in turn is connected to and in fluid communication with second horizontal section 109. Second horizontal section 109, in embodiments of the invention, is connected to and in fluid communication with second vertical section 110. According to embodiments of the invention, second horizontal section 109 has inlet 117, located proximate to the connection of second horizontal section 109 and second vertical section 110, where inlet 117 is adapted to allow aeration gas to be fed into second horizontal section 109.

According to embodiments of the invention, loop-seal 106, via second vertical section 109, is connected to and in fluid communication with dogleg 111. In embodiments of the invention, dogleg 111 comprises a pipe slanted at an angle in a range of 25 to 60 degrees of the horizontal axis. Dogleg 111 may be connected to and in fluid communication with second dipleg 112. According to embodiments of the invention, first stage dipleg 105, loop-seal 106 (and its various components), dogleg 111, and dipleg 112 are comprised of pipes that may have cross sectional area selected from circular, rectangular, triangular, oblong, and the like. Cylindrical body 103 may have a diameter of 1 to 1.6 mm. And the ratio of the diameter of cylindrical body 103 to diameter (longest cross sectional distance) of first stage dipleg 105 may be 2.5 to 11.

FIG. 2 shows method 20 for producing olefins and/or aromatics, according to embodiments of the invention. Method 20 can begin at block 200, which involves cracking naphtha in reactor 113 that has a catalyst fluidized bed to form a gas product comprising one or more olefins and/or one or more aromatics. In embodiments of the invention, the catalytic cracking of naphtha can involve the conversion of hydrocarbon mixtures with final boiling point of under 350° C. to light olefins (i.e., ethylene, propylene, and/or butylene) and/or aromatics (i.e., benzene, toluene, and/or xylene). Reactor hydrodynamics and reaction kinetics can be varied to achieve a wide range of product distribution. Reactor designs can include circulating fluidized bed (CFB) reactors with various configurations, such as one to four turbulent fluidized bed reactors (TFBR)/fast-fluidized bed reactors (FFBR) with or without baffles, and one to four dense-phase risers. According to embodiments of the invention, because the gas product is produced in a reactor that has a fluidized bed, the effluent from reactor 113 comprises a mixture that includes catalyst particles and the gas product. At block 201, the mixture comprising the catalyst particles and the gas product is flowed from reactor 113 (having the catalyst fluidized bed), to a cyclone, such as cyclone 100 of system 10.

According to embodiments of the invention, cyclone 100 includes inlet 101, through which the mixture of catalyst particles and the gas product is flowed into cyclone 100. Cyclone 100 further includes cylindrical body 103, which is adapted to cause a circular flow of the mixture such that cyclone effluent flowing through top outlet 102 comprises higher gas to solids ratio than the incoming mixture, i.e., a lighter portion of the mixture. In other words, some of the solids are separated from the mixture and those solids along with some gas product, i.e., a heavier portion of the mixture, moves downwards towards narrowing section 104 and into first stage dipleg 105.

In conventional cyclone dipleg/configurations, the first stage diplegs often operate in streaming flow (dilute region), where solids entering the cyclone drag the gas down. This phenomenon is called “gas recirculation,” and could potentially bring down as much as ⅓^{rd} of the inlet gas (i.e., 33%). The gas recirculation increases with the increase in superficial gas velocity (SGV), solids flux and/or fine content of catalyst entering the first stage cyclone. When diplegs operate in the desired dense-phase mode, only about 2-3% of the gas entering the cyclone flows down the dipleg with the solids. In embodiments of the invention, the dense phase mode operation can be defined by the presence of high solids volume fractions of the order of greater than 0.3 in the first 3-5 feet above dipleg termination. The extent of the phenomenon of gas recirculation can be reduced by creating a dense seal in the dipleg (measured pressure drop per unit length) or by reducing solids flux into the first stage cyclone.

Thus, according to embodiments of the invention, first stage dipleg 105 is adapted to receive aeration gas (e.g., nitrogen and methane) via aeration nozzles 114, disposed in first stage dipleg 105. Injecting the aeration gas through nozzles 114 has the effect of avoiding defluidization of particles in the dipleg through aeration. In embodiments of the invention, first stage dipleg 105 is connected to and in fluid communication with loop-seal 106 such that the heavier portion of the mixture flows downward through first stage dipleg 105 and into loop-seal 106, specifically, first horizontal section 107. In embodiments of the invention, first horizontal section 107 includes gas distributor 115, through which fluidizing gas is flowed into first horizontal section 107 to contact and fluidize material in first horizontal section 107. Injecting the fluidizing gas through gas distributor 115 has the effect of avoiding defluidization of particles in the dipleg through aeration. First vertical section 108 is connected to and in fluid communication with first horizontal section 107 such that catalyst particles from first horizontal section 107 move up first vertical section 108. According to embodiments of the invention first vertical section 108 is adapted to receive aeration gas (e.g., nitrogen and methane) via aeration nozzles 116, disposed in first vertical section 108. Injecting the aeration gas through nozzles 116 has the effect of avoiding defluidization of particles in the dipleg through aeration. Second horizontal section 109 is in fluid communication with first vertical section 108 such that catalyst particles from first vertical section 108 move into second horizontal section 109. According to embodiments of the invention, second horizontal section 109 is adapted to receive aeration gas (e.g., nitrogen and methane) via aeration inlet 117 disposed at the intersection of first second horizontal section 109 and second vertical section 110. Injecting the aeration gas through nozzles 116 has the effect of avoiding defluidization of particles in the dipleg through aeration, whereas, aeration gas nozzles 117 also help to break potential vacuum in the line. In embodiments of the invention, second vertical section 110 is in fluid communication with second horizontal section 109 such that catalyst particles from second horizontal section 109 move down second vertical section 110. Loop-seal 106, having first horizontal section 107, first vertical section 108, second horizontal section 109, and second vertical section 110, is configured to primarily transfer catalyst particles with adsorbed hydrocarbons down the dipleg close to the bottom of the reactor encompassing the cyclone(s) by separating most of the gas that enters the first stage cyclone.

Thus, according to embodiments of the invention, at block 202, method 20 includes restricting flow of the gas product through loop-seal 106 to an extent greater than any restriction of flow of the catalyst particles through loop-seal 106. In embodiments of the invention, the restricting of block 202 is such that gas product to catalyst particles ratio upstream loop-seal 106 is higher by at least 50% than gas product to catalyst particles ratio downstream loop-seal 106. At block 203, according to embodiments of the invention, effluent from loop-seal 106 is flowed through dogleg 111, then flowed through dipleg 112 and unto gas stripper 118. At block 204, in embodiments of the invention, gas stripper 118 strips remaining hydrocarbons from the catalyst particles. Because loop-seal 106 is disposed on first stage dipleg 105, according to embodiments of the invention, the need for stripping hydrocarbons from the spent catalyst, and stripping gas requirements, can be minimized and the activity of the catalyst can be more easily maintained, as compared with conventional methods because of a lower amount of entrained hydrocarbon entering the stripper.

In the context of the present invention, at least the following 18 embodiments are described. Embodiment 1 is a method of producing olefins and/or aromatics. The method includes cracking naphtha in a catalyst fluidized bed to form a gas product containing one or more olefins and/or one or more aromatics. The method further includes flowing a mixture containing catalyst particles and the gas product, from the catalyst fluidized bed, to a cyclone, wherein a loop seal is in fluid communication with a first dipleg of the cyclone. The method still further includes restricting flow of the gas product through the loop seal to an extent greater than any restriction of flow of the catalyst particles through the loop seal. Embodiment 2 is the method of embodiment 1, wherein the gas product contains one or more of: ethylene, propylene, butylene, benzene, toluene, and xylene. Embodiment 3 is the method of any of embodiments 1 or 2, wherein the restricting is such that gas product to catalyst particles ratio upstream the loop seal is higher by at least 50% than gas product to catalyst particles ratio downstream the loop seal. Embodiment 4 is the method of embodiment 3, wherein the gas product to catalyst particles ratio upstream the loop seal is higher by at least 90% than the gas product to catalyst particles ratio downstream the loop seal. Embodiment 5 is the method of any of embodiments 1 to 4, further including flowing effluent from the loop seal to a gas stripper. Embodiment 6 is the method of embodiment 5, further including stripping at least some hydrocarbons from catalyst particles in the effluent from the loop seal. Embodiment 7 is the method of any of embodiments 1 to 6, wherein the fluidized bed includes a selection from the list consisting of: a circulating fluidized bed, a turbulent fluidized bed, and a fast fluidized bed. Embodiment 8 is the method of any of embodiments 1 to 7, wherein the cyclone is the first of a plurality of cyclones in series. Embodiment 9 is the method of any of embodiments 1 to 8, wherein the loop seal is connected to and in fluid communication with a dogleg. Embodiment 10 is the method of embodiment 9, wherein the dogleg is connected to and in fluid communication with a second dipleg. Embodiment 11 is the method of any of embodiments 1 to 10, wherein the loop seal includes two horizontal sections and two vertical sections. Embodiment 12 is the method of embodiment 11, wherein a first horizontal section includes a gas distributor. Embodiment 13 is the method of embodiment 12, further including injecting fluidizing gas into the first horizontal section via the gas distributor. Embodiment 14 is the method of embodiment 13, wherein the fluidizing gas contains one or more of: nitrogen and methane. Embodiment 15 is the method of embodiment 11, wherein the two vertical sections include aeration gas nozzles. Embodiment 16 is the method of embodiment 15, further including injecting aeration gas into the one or more of the two vertical sections. Embodiment 17 is the method of embodiment 16, wherein the aeration gas contains one or more of: nitrogen and methane. Embodiment 18 is the method of any of embodiments 1 to 17, wherein the first dipleg of the cyclone is operated in dense-phase mode.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing olefins and/or aromatics, the method comprising:
cracking naphtha in a catalyst fluidized bed to form a gas product comprising one or more olefins and/or one or more aromatics;
flowing a mixture comprising catalyst particles and the gas product, from the catalyst fluidized bed, to a cyclone, wherein a loop seal is in fluid communication with a first dipleg of the cyclone; and
restricting flow of the gas product through the loop seal to an extent greater than any restriction of flow of the catalyst particles through the loop seal.

2. The method of claim 1, wherein the gas product comprises one or more of: ethylene, propylene, butylene, benzene, toluene, and xylene.

3. The method of claim 1, wherein the restricting is such that gas product to catalyst particles ratio upstream the loop seal is higher by at least 50% than gas product to catalyst particles ratio downstream the loop seal.

4. The method of claim 3, wherein the gas product to catalyst particles ratio upstream the loop seal is higher by at least 90% than the gas product to catalyst particles ratio downstream the loop seal.

5. The method of claim 1, further comprising:
flowing effluent from the loop seal to a gas stripper.

6. The method of claim 5, further comprising stripping at least some hydrocarbons from catalyst particles in the effluent from the loop seal.

7. The method of claim 1, wherein the fluidized bed comprises a selection from the list consisting of: a circulating fluidized bed, a turbulent fluidized bed, and a fast fluidized bed.

8. The method of claim 1, wherein the cyclone is the first of a plurality of cyclones in series.

9. The method of claim 1, wherein the loop seal is connected to and in fluid communication with a dogleg.

10. The method of claim 9, wherein the dogleg is connected to and in fluid communication with a second dipleg.

11. The method of claim 1, wherein the loop seal comprises two horizontal sections and two vertical sections.

12. The method of claim 11, wherein a first horizontal section comprises a gas distributor.

13. The method of claim 12, further comprising:
injecting fluidizing gas into the first horizontal section via the gas distributor.

14. The method of claim 13, wherein the fluidizing gas comprises one or more of: nitrogen and methane.

15. The method of claim 11, wherein the two vertical sections comprise aeration gas nozzles.

16. The method of claim 15, further comprising:
injecting aeration gas into one or more of the two vertical sections.

17. The method of claim 16, wherein the aeration gas comprises one or more of: nitrogen and methane.

18. The method of claim 1, wherein the first dipleg of the cyclone is operated in dense-phase mode.

19. The method of claim 3, wherein the first dipleg of the cyclone is operated in dense-phase mode.

20. The method of claim 4, wherein the first dipleg of the cyclone is operated in dense-phase mode.
